(19) United States
(12) Patent Application Publication
(10) Pub. No.: US 2008/0228963 A1
(43) Pub. Date: Sep. 18, 2008

(54) Method and apparatus for transferring settings and other configuration information from one consumer electronics device to another

(76) Inventors: Takashi Hironaka, San Diego, CA (US); Rajesh Kechal Rao, San Marcos, CA (US); Thomas Patrick Dawson, Escondido, CA (US); Ludovic Douillet, Escondido, CA (US); George Williams, Carlsbad, CA (US)

Correspondence Address: MAYER & WILLIAMS PC, 251 NORTH AVE. WEST, 2ND FLOOR, WESTFIELD, NJ, 07090, US

(21) Appl. No.: 11/724,631

(22) Filed: Mar. 15, 2007

(51) Int. Cl. G06F 3/00

(52) U.S. Cl. 710/36

(57) ABSTRACT

A method and apparatus is provided for inputting user-selected settings to a second consumer electronic device. The method begins by establishing a first communication path between a first consumer electronic device and the second consumer electronic device. The first communication path is configured to transfer content to be rendered by at least one of the devices. The first device is queried over the first communication path to identify user-selected settings established in the first device that are applicable to the second device. In response to the query, the applicable user-selected settings are transferred over the first communication path from the first device to the second device. The transferred applicable user-selected settings are stored in respective fields of a settings database associated with the second device.

### FIELD OF THE INVENTION

The present invention relates generally to user-selectable settings in consumer electronic devices such as televisions, and more particularly to a method and apparatus for automatically transferring settings and other configuration information from one consumer electronics device to another.

### BACKGROUND OF THE INVENTION

Modern televisions may receive video and other input from a wide variety of peripheral devices such as digital video cameras, set-top boxes, media players, digital video recorders, game consoles and the like. Many of these peripheral devices, as well as the television itself, require the user to initially configure the device by selecting setting for various items such as the time, date, language, sleep modes, screen saver modes, closed-caption settings, and alarms, for example. This configuration process can be time consuming and cumbersome, particularly when it must be performed for so many different devices. Moreover, whenever it is necessary to change the settings in one device it is also necessary to change the settings for some or all of the other devices. For example, when transitioning between daylight savings time and standard time, the time fields of all the devices need to be changed. Similarly, for those devices that are network-enabled, it may be necessary to change the IP or other network address settings when the user's network is reconfigured. Since so many of the required settings on these devices are the same, it would be advantageous if the user did not have to enter the same information multiple times on each and every device.

### SUMMARY OF THE INVENTION

In accordance with the present invention, a method and apparatus is provided for inputting user-selected settings to a second consumer electronic device. The method begins by establishing a first communication path between a first consumer electronic device and the second consumer electronic device. The first communication path is configured to transfer content to be rendered by at least one of the devices. The first device is queried over the first communication path to identify user-selected settings established in the first device that are applicable to the second device. In response to the query, the applicable user-selected settings are transferred over the first communication path from the first device to the second device. The transferred applicable user-selected settings are stored in respective fields of a settings database associated with the second device.

In accordance with one aspect of the invention, the first communication path may comprise a USB connection.

In accordance with another aspect of the invention, at least one of the applicable user-selected settings may be selected from the group consisting of time, date, language, sleep modes, screen saver modes, closed-caption settings, and alarms.

In accordance with another aspect of the invention, the query may be performed in response to initialization of one of the devices.

In accordance with another aspect of the invention, the user-selected settings may be stored in an XML file format.

In accordance with another aspect of the invention, the consumer electronic device may be a television.

In accordance with another aspect of the invention, the applicable user-selected settings transferred to the second device may be compared with previously input user-selected settings in the second device and at least one of the previously input settings may be replaced with a corresponding one of the transferred user-selectable settings.

In accordance with another aspect of the invention, a set of user-selected settings associated with the second device may be transferred over the first communication path to the first device and the set of user-selected settings may be stored in a settings database of the first device.

In accordance with another aspect of the invention, a second communication path may be established between the first consumer electronic device and a third consumer electronic device and at least one applicable setting from the set of user-selected settings associated with the second device may be transferred over the second communication path to the third electronic device.

In accordance with another aspect of the invention, the applicable user-selected settings may include settings common to both the first consumer electronic device and the second consumer electronic device.

In accordance with another aspect of the invention, the applicable user-selected settings may include settings used by the second consumer electronic device and not the first consumer electronic device.

In accordance with another aspect of the invention, a consumer electronic device is provided. The device includes a unit for rendering or recording content and a user-interface for entering settings into user-selectable fields. The settings each define a configuration of the rendering or recording unit. A settings database is provided for storing the settings in their respective user-selectable fields and a communications port is provided for communicating with an external device. A configuration manager transfers applicable user-selected settings from an external device operatively coupled to the communications port to fields in the settings database.

### BRIEF DESCRIPTION OF THE DRAWINGS

FIG. 1 shows a television and various peripheral devices that may be coupled to the television by input/output (I/O) busses.

FIG. 2 is a block diagram showing the relevant components within the television and one of the peripheral devices depicted in FIG. 1.

FIG. 3 is a flowchart showing one example of a method that may be employed for inputting user-selected settings to a second consumer electronic device.

### DETAILED DESCRIPTION

In recent years, with the wide-spread introduction of digital broadcasting, audio/video equipment such as televisions, Digital Video Recorders (DVRs) and video cameras have become available in digital form and, as a result, the use of appropriate digital audio/video communication standards has increased. As detailed below, the present invention uses such standards to provide a method and apparatus for automatically transferring user-selectable settings that have been inputted in one device such as a television to any peripheral device that may be connected to and in communication with the television. In this way settings that have been selected by the user for his or her television can be input to the peripheral devices without the need to manually enter the settings into the peripheral devices. Upon connecting the peripheral device to the television a notification is transmitted from one device to the other when a setting or configuration is initially created or updated. The various devices (e.g, the television and the peripheral devices) each include a configuration manager and a settings database to implement these features.

One communication standard that may be used to communicate setting information between a television and peripheral devices is the Universal Serial Bus (USB), which is a serial bus standard to interface devices. While was originally designed for computers, its use has become more common on video game consoles, PDAs, portable DVD and media players, cellphones and even devices such as televisions, home stereo equipment (e.g., digital audio players), car stereos and portable memory devices.

One advantage of USB technology is when a peripheral device is connected to a host's USB bus, the device is immediately recognized by the host, dynamically enumerated, and assigned an address. The host and the device then perform a query/response protocol to enable the host to obtain information about the device, such as the class of device and various other details that the host computer needs to know for its operation. The USB standards define various broad device classes for certain well-known kinds of devices, such as “Printer”, “Human Interface Device”, “Audio”, “Video”, “Mass Storage”, etc. Operating systems that support USB technology typically include preloaded drivers for these USB device classes. If a new USB device connected to the host belongs to one of these USB device classes, then the host can often simply configure communication with the new device to occur using the driver for the appropriate USB device class. Thus, the user is not required to install a driver specifically for the device, and a vendor is not required to develop a driver specifically for the device.

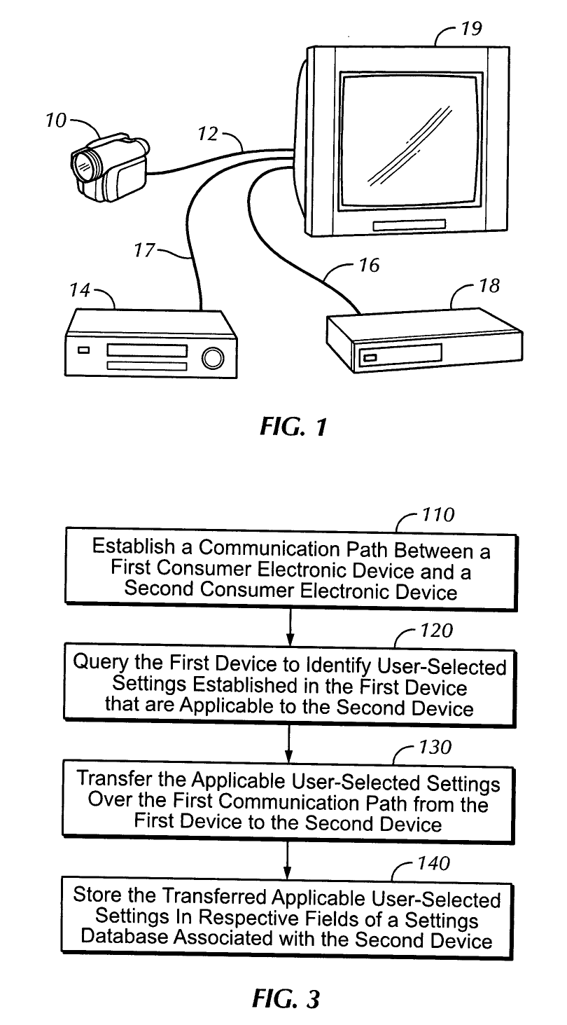

FIG. 1 shows a television 19 and various peripheral devices such as a video camera 10, a video cassette recorder 14, and a set-top box 18 which are coupled to the television 19 by the input/output (I/O) busses 12, 16 and 17. The I/O bus 12 couples the video camera 10 to the television 19, allowing the video camera 10 to send data to the television 19 for display. Through the I/O bus 12, the television 12 is also able to send communications to the video camera 10. The I/O bus 16 couples the television 19 to the set-top box 18, allowing the set-top box 18 to send data to the television 19 for display and allowing the television 19 to send communications to the set top box 18. The I/O bus 17 couples the video cassette recorder 14 to the television 19 allowing the video cassette recorder 14 to send data to the television 19 for display. In some embodiments the I/O busses 12, 16 and 17 are USB busses. It should, however, be apparent to those skilled in the art that any other appropriate bus or network configuration may be used to couple the devices together. For example, another suitable standard is the IEEE 1394 digital interface. This interface can mutually connect digital audio/video devices, and enables such device to be networked and exchange audio/video data streams with one other. Among other features, this communication standard allows a television to automatically recognize that an external device is connected to it through an IEEE 1394 bus.

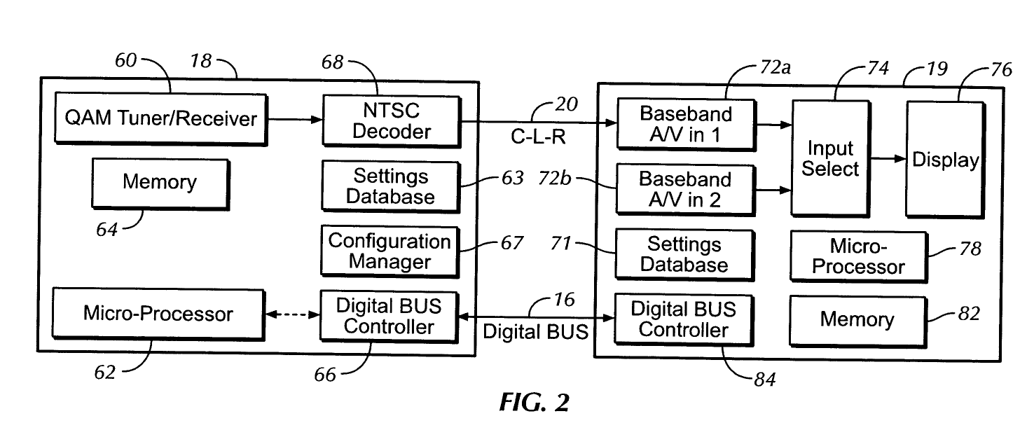

A block diagram of the relevant components within the television 19 and one of the peripheral devices, in this case set top box 18, is shown in FIG. 2. STB 18 is representative of any peripheral device that may be connected to a television, including the previously mentioned peripheral devices. STB 18 may comprise a tuner/receiver module 60 which demodulates the signal of interest, a microprocessor 62 and memory 64 which provides for the main control and coordination of resources within the box, a digital bus controller 66 which manages how data is transmitted or received to or from other devices, and an NTSC decoder 68 with video mixer which provides the capabilities to overlay on-screen displays. Analog video signals are tuned and demodulated and decomposed into composite video and left-right audio in the tuner/demodulator. Digital audio-video signals may be passed directly to the digital bus 16 for decoding in the digital television. The analog audio-video output of the set-top box, which consists of composite video with left and right audio signals (C-L-R), are passed to cable 20.

Set top box 18 also includes a settings database 63 that stores various user-selected values for various settings including, without limitation, such fields as the time, date, language, sleep modes, screen saver modes, closed-caption settings, and alarms. The user can set the values for the various items in the settings database in a well-known manner through a user input (not shown) that may, for example, present a menu on the television or other display device.

A configuration manager 67 is located in set top box 18 for interacting with television 19 and for downloading from the television 19 any available user-selectable settings that are needed by the set top box. The configuration manager 67 includes a listing of the known fields for the set top box that are user-selectable as well as the currently selected values or settings for those fields. The configuration manager 67 can determine those settings stored in television 19 which are applicable to the set top box 18, and apply those settings to the set top box. The configuration manager 67 can also send the set top box settings to the television 19 for future reference, such as in the event it becomes necessary to re-input the settings into the set top box should the set top box lose its previous setting.

TV 19 may comprise a set of one or more baseband audio/video inputs 72a and 72b including a grouped collection of composite video and left and right audio signals. Typically these are color coded physically located to infer a logical grouping of signals. Many television sets have more than one grouping as demonstrated in the diagram. These multiple input groups are routed to an input selector 74. The input selector will choose the particular input grouping for presentation on the display 76 and audio speakers (not shown). TV 19 also consists of a microprocessor 78 and memory 82 for the purposes of controlling the hardware resources within the television set and a digital bus controller 84 for interconnection with other devices.

Similar to set top box 18, television 19 also includes a settings database 71 that stores various user-selected values for various settings including, without limitation, such fields as the time, date, language, sleep modes, screen saver modes, closed-caption settings, and alarms. The user can set the values for the various fields in the settings database in a well-known manner through a user input. The settings database 71 saves the settings associated with the television 19 as well as the settings used in the peripheral device or devices to which the television 19 is attached.

Although a specific architecture has been described in FIG. 2 for the television and peripheral device, including specific functional elements and relationships, it is contemplated that the systems and methods described herein may be implemented in a variety of ways. For example, functional elements may be packaged together or individually, or may be implemented by fewer, more or different devices, and may be either integrated within other products, or adapted to work with other products externally. When one element is indicated as being responsive to another element, the elements may be directly or indirectly coupled. In particular, configuration manager 67 may reside in any combination of software, firmware and hardware.

In accordance with the present invention, user-selected settings are accessed during initialization, e.g., during power on or reset, of the set top box 18 when it is connected to the TV 19 via bus 16. At initialization, the configuration manager 67 in the peripheral device sends a query to the television 19 requesting the television to access from memory user-selected settings for various fields. In this example, the query requests the current settings for the time, date and language fields. The requested settings are downloaded from the television 19 to the configuration manager 67 in the peripheral device. The configuration manager 67 processes the received information and then populates the fields of the settings database 63 with the appropriate values. More specifically, the configuration manager 67 compares the current settings (if any) of each field in its settings database with settings received from the television 19. For those fields in which the settings are not the same, the configuration manager 67 replaces the settings in the settings database with the setting received from the television 19 for the corresponding field.

If a user creates or updates a setting or configuration when the television is subsequently placed in communication with the STB 18 or other peripheral device, the communication manager in the peripheral device will be notified of the change and will request the new setting for the field or fields that have been updated.

The configuration manager 67 uses a configuration exchange protocol to communicate with television 19. This protocol exchanges data files that can be prepared and generated independently of the communication medium, e.g., a USB bus. That is, the contents and structure of the files can be independent of the medium the file is transported across. In one embodiment, the file format uses the eXtensible Markup Language (XML) to store the information, but a person skilled in the art will recognize that any structure can be used to store the information in the message. Similarly, the files sent to the set top box 18 can have similar or identical content, even though packaged for transmission along different media. Thus, for example, a file containing configuration settings can be sent along any communication medium, and can be understood by the configuration manager 67, even though sent along different communication media, and therefore packaged differently.

One reason for using a structure such as XML is that it decouples the content of the file from the communication medium. With the content of a file being independent from the communication medium over which the file is to be transmitted, configuration manager 67 does not have to deal with low level communication protocols. There are other advantages to an embodiment that uses a structure, like XML, that is independent of the communication medium. For example, when a message uses an encoding that packs the information and interprets a particular bit to have a particular meaning, both the television and the device need to know how to generate and interpret such encodings. If the encoding is dependent on the communication medium used to transmit the message, the television and the peripheral device need to know how to generate and interpret multiple encodings, which increases complexity (since any change to the data to be transmitted might have to be propagated to each encoding). By using a structure like XML that is independent of the medium (and also independent of the protocol), the television and the peripheral device both only need to know how to interpret one structure: in the illustrative embodiment, XML.

It should be noted that the settings may be communicated to the peripheral device from the television in either a push or pull manner, depending on how the configuration exchange protocol is structured. In a typical client/server environment involving a pull, the client engages a server with a request for service or information. The server responds to the request and returns information to the client. This interaction is referred to as a pull, since the customer is effectively pulling information from the server. In the example presented above the settings are communicated in the manner of a pull since the set-top box initiates the request. In a push interaction, the server transmitting information to the client without explicit instruction from the client to do so. This interaction is referred to as a push, since the server is effectively pushing information to the client. In the present case the television may push the settings located in the settings database 71 to the peripheral device whenever they are connected to one another through a USB bus.

The ability to exchange settings between and among various consumer electronic devices in the manner described above provides a number of advantages. For example, it allows the user to avoid entering the same setting multiple times in each device. For instance, once a language option in the menu of a first device is chosen to be English, that setting can be shared with other devices that are connected to the first device. In addition, one device, such as the television, for example, can store the settings of all the other devices in its nonvolatile memory. In the event that a device loses its settings, it can readily retrieve them from the television without requiring the user to manually re-enter them. The settings that can be retrieved may include those that are commonly shared among the devices as well as those settings that are specific to the device retrieving them. Examples of device specific settings are, for example, chapter repeat mode (in the case of a DVD player), a list of recorded programs (in the case of a DVR), and so on. Thus, if a DVD player were to break and was replaced with a new DVD player, the settings for the new player can be transferred from the television upon connecting the two devices. In this way the user does not have to input the settings from scratch.

Another feature of the arrangement described above is that one device can query another concerning its settings. For example, if a DVD recorder, which has many of the same setting options as a DVD player, wants to use the settings from the DVD player, the DVD recorder can send a query to the television to retrieve the DVD player settings and forward them to the DVD recorder. The configuration manager in the DVD recorder can determine which settings obtained from the DVD player are applicable to the DVD recorder. In this way one device can collect the settings from another device and determine which settings are applicable for its purposes. The device will then only prompt the user to manually enter those settings that are not available from the other device.

FIG. 3 is a flowchart showing one example of a method that may be employed for inputting user-selected settings to a second consumer electronic device. The method begins in step 110 by establishing a first communication path between a first consumer electronic device and the second consumer electronic device. The first communication path is configured to transfer content to be rendered by at least one of the devices. Next, in step 120, the first device is queried over the first communication path to identify user-selected settings established in the first device that are applicable to the second device. In response to the query, the applicable user-selected settings are transferred over the first communication path from the first device to the second device in step 130. In step 140, the transferred applicable user-selected settings are stored in respective fields of a settings database associated with the second device.

Although various embodiments are specifically illustrated and described herein, it will be appreciated that modifications and variations of the present invention are covered by the above teachings and are within the purview of the appended claims without departing from the spirit and intended scope of the invention. For example, while the invention has been described in terms of a method and apparatus for transferring settings between a television and a peripheral device, the invention is also applicable to a wide variety of consumer electronic devices other than televisions. For example, the invention is applicable to any peripheral device that can be connected to any consumer electronic device such as an audio player or receiver.

1. A method for inputting user-selected settings to a second consumer electronic device, comprising:
establishing a first communication path between a first consumer electronic device and the second consumer electronic device, said first communication path being configured to transfer content to be rendered by at least one of the devices;
querying the first device over the first communication path to identify user-selected settings established in the first device that are applicable to the second device;
in response to the query, transferring over the first communication path the applicable user-selected settings from the first device to the second device; and
storing the transferred applicable user-selected settings into respective fields of a settings database associated with the second device.

2. The method of claim 1 wherein the first communication path comprises a USB connection.

3. The method of claim 1 wherein at least one of the applicable user-selected settings is selected from the group consisting of time, date, language, sleep modes, screen saver modes, closed-caption settings, and alarms.

4. The method of claim 1 wherein the query is performed in response to initialization of one of the devices.

5. The method of claim 1 wherein the user-selected settings are stored in an XML file format.

6. The method of claim 1 wherein one of the consumer electronic devices is a television.

7. The method of claim 1 further comprising comparing the applicable user-selected settings transferred to the second device with previously input user-selected settings in the second device and replacing at least one of the previously input settings with a corresponding one of the transferred user-selectable settings.

8. The method of claim 1 further comprising:
transferring over the first communication path to the first device a set of user-selected settings associated with the second device; and
storing the set of user-selected settings into a settings database of the first device.

9. The method of claim 8 further comprising:
establishing a second communication path between the first consumer electronic device and a third consumer electronic device; and
transferring over the second communication path at least one applicable setting from the set of user-selected settings associated with the second device to the third electronic device.

10. The method of claim 1 wherein the applicable user-selected settings include settings common to both the first consumer electronic device and the second consumer electronic device.

11. The method of claim 1 wherein the applicable user-selected settings include settings used by the second consumer electronic device and not the first consumer electronic device.

12. A consumer electronic device, comprising:
a unit for rendering or recording content;
a user-interface for entering settings into user-selectable fields, said settings each defining a configuration of the rendering or recording unit;
a settings database for storing the settings in their respective user-selectable fields;
a communications port for communicating with an external device;
a configuration manager for transferring applicable user-selected settings from an external device operatively coupled to the communications port to fields in the settings database.

13. The consumer electronic device of claim 12 wherein the communications port is operable in connection with a USB protocol.

14. The consumer electronic device of claim 12 wherein at least one of the applicable user-selected settings is selected from the group consisting of time, date, language, sleep modes, screen saver modes, closed-caption settings, and alarms.

15. The consumer electronic device of claim 12 wherein the applicable user-selectable settings are transferred upon initialization of one of the devices.

16. The consumer electronic device of claim 12 wherein the user-selected settings are stored in the settings database in an XML file format.

17. The consumer electronic device of claim 12 wherein the configuration manager compares the applicable user-selected settings transferred to the external device with previously input user-selected settings in the external device and replaces at least one of the previously input settings with a corresponding one of the transferred user-selectable settings.

18. The consumer electronic device of claim 12 wherein the applicable user-selected settings include settings common to both the consumer electronic device and the external device.

19. The consumer electronic device of claim 12 wherein the applicable user-selected settings include settings used by the external device and not the consumer electronic device.

20. The consumer electronic device of claim 12 wherein the unit comprises a television receiver.
